(19) United States
(12) Patent Application Publication
(10) Pub. No.: US 2006/0294437 A1
(43) Pub. Date: Dec. 28, 2006

(54) POINT-OF-LOAD POWER CONDITIONING FOR MEMORY MODULES

(75) Inventors: Robert D. Washburn, Malibu, CA (US); Robert F. McClanahan, Valencia, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(73) Assignee: Thunder Creative Technologies, Inc., Malibu, CA (US)

(21) Appl. No.: 11/425,978

(22) Filed: Jun. 22, 2006

Related U.S. Application Data
(60) Provisional application No. 60/693,137, filed on Jun. 22, 2005.

(51) Int. Cl. G06F 11/00

(52) U.S. Cl. 714/42

(57) ABSTRACT

The invention is a point-of-load power conditioning system for computer memory modules that provides regulation and fast transient response for memory integrated circuit bias voltages. The invention uses low voltage drop regulation circuitry that is physically located on individual memory modules. Power consumption and memory module regulator power dissipation are minimized by use of off-module power preconditioning that provides module input power at an optimized voltage for the on-module regulator circuitry.

### CROSS-REFERENCE TO RELATED APPLICATIONS

This application claims the benefit of U.S. Provisional Application No. 60/693,137, filed Jun. 22, 2005, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Typically, personal computers, workstations and servers use memory modules that receive pre-regulated electrical power from the motherboard through a single module interface connector. Multiple regulated bias voltages are typically provided. For common 184-pin, 2.5 Volt (VDD)/2.5 Volt (VDDQ), Unbuffered, Non-ECC, Double Data Rate, Synchronous DRAM Dual In-Line Memory Modules (DDR SDRAM DIMMs), henceforth referred to as DIMMs, three bias voltages are provided. These voltages and an example configuration can be seen in FIG. 1. The bias voltages are the SDRAM memory integrated circuit (IC) positive power supply voltage (VDD) the SDRAM I/O driver positive power supply voltage (VDDQ) and the SDRAM I/O reference supply voltage (VREF). VREF is low current and supplied (typically) over a single input pin. VDD and VDDQ along with their respective return lines (VSS and VSSQ) are applied through multiple pins for each that are distributed along the module interface connector.

There are several problems associated with the DIMM power system such as illustrated in the example of FIG. 1. The problems include:

1. Remote location of the regulator output with respect to memory ICs on DIMMs limits regulator transient load response time.

2. Wide regulator output current supply range, that theoretically varies from 1 DIMM with 1 bank of non-ECC slow memory IC to 4 DIMMs of 4 banks of ECC fast memory ICs, requires large output capacitance that further limits response transient response time.

3. Motherboard switching regulation produces high frequency switching noise that is present on DIMM bias voltages and is picked up on control and data lines within the memory buss. The switching noise alters DIMM timing and limits realizable DIMM operating speed.

4. Although capable of providing specified DIMM bias voltage levels, many memory ICs/DIMMs achieve maximum performance at bias voltage levels that are both above specification and above the maximum voltage that can be supplied by most motherboards (typically +2.85VDC).

Despite the above problems and the limitations of DIMM performance, the approach of FIG. 1 is the choice for virtually all PCs and servers and is specified by industry standards organizations such as JEDEC. This is done because there are so many additional and even more significant performance limiters than noise on the power forms. However, if higher speed memory module performance is to be realized, particularly on large memories, all of the significant limiting factors must be overcome, including those associated with DIMM power generation, regulation and distribution.

An alternate approach is illustrated in FIG. 2, which uses a linear regulator module that plugs into one of the memory buss DIMM connectors (e.g. DIMM 105 includes power regulator module 200). The regulator module 200 provides bias voltages to the remaining DIMM interface connectors over the same motherboard power interconnections used in the typical distribution system shown in FIG. 1. Voltages supplied are nominally above the levels that would otherwise be provided by the switching converters located on the motherboard. The higher voltages supplied by the linear regulator module back bias the motherboard supplies and effectively turn them off. The approach of FIG. 2 is often used for specialty applications such as high speed gaming where one single bank memory module is operated in both over-voltage and over-clocked modes.

One advantage of the alternate approach of FIG. 2 is lower noise. DIMMs are driven by the output of a linear regulator as opposed to the motherboard switching converter. The linear regulator reduces power converter switching noise on the bias voltages as well as that picked-up on control and data lines comprising the memory buss. Digital switching noise and crosstalk are not significantly impacted by the alternate approach.

However, there are several disadvantages associated with the approach illustrated in FIG. 2. The regulator remains remotely located with respect to memory ICs with significant inductance between the regulator output and memory ICs. This effectively limits the response time of the DIMM power supply and requires substantially greater energy storage on DIMMs to prevent pulse load voltage changes at the individual memory ICs that significantly alter module timing and add to timing margin problems for high-speed operation. The added energy storage is not available on existing DIMMs. Although the approach is typically not worse than with the approach in FIG. 1, it does not resolve the problems associated with remotely located regulator circuitry. Resolution of the problems is necessary to achievement of a substantial increase in memory module operating speeds.

The second disadvantage of the approach of FIG. 2 is that it uses one of the motherboard DIMM connector slots, which is then not available for DIMM installation. This approach limits the number but also the form of DIMMs that can be installed since some are provided as matched DIMM pairs.

Finally, another problem associated with the approach shown in FIG. 2 is the high power dissipation localized on DIMM Power Regulator 200. Since DIMM Regulator Module 200 requires an external power form and only +5VDC is available with adequate current capability, approximately 50% of the input power will be dissipated within DIMM Regulator Module 200. Localization of the dissipation level in the regulator complicates the system design since a dedicated cooling system is frequently required for DIMM Regulator Module 200. An acceptable approach to power one or perhaps two memory banks, power consumption becomes excessive for operation of large memories at high frequencies.

Realization of high frequency operation in memory modules is typically limited by design timing margin that is necessary to meet required setup and hold time requirements (without requiring increased clock latency) for memory ICs. Although there are many factors that contribute to timing margin in a design, one item that reduces the margin during memory module operation is timing drift. Operating temperature changes that result directly from device heating due to power dissipation within the memory ICs are a cause of timing drift. The power dissipation varies over a wide range as a function of memory utilization and access rates. At present, DIMMs have no dynamic means for limiting or correcting timing drift. Drift must therefore be absorbed within the timing margin of the design.

### SUMMARY

The invention is a point-of-load power conditioning system for computer memory modules. The system combines memory module bias power preconditioning with on-module linear regulation. The invention has fast transient load response and settling time. Noise levels on both the memory module and motherboard are reduced compared to the present art, providing a contribution to achievement of higher frequency memory operation.

The invention has the ability to simultaneously achieve tighter regulation of memory integrated circuit bias voltages, faster transient load response and settling time, lower memory module noise levels, tighter tracking between VDDQ and VREF for the memory ICs, high efficiency, and the capability to reduce and correct timing drift.

In one or more embodiments, the invention provides both VDD and VDDQ voltages from one on-module regulator.

In one or more embodiments, the invention is configured with 2 substantially identical on-module regulator circuits that provide either separate regulation for VDD and VDDQ respectively or power one half of the memory ICs for memory modules having multiple memory banks.

In one or more embodiments, the invention regulates VDD and VDDQ to provide different voltages.

In one or more embodiments, the invention is configured to have one, on-module, linear, regulation circuit for each memory integrated circuit bank position. Each of the regulation circuits provides bias power to all memory ICs in all memory banks in the position.

In one or more embodiments, the invention generates the reference voltage applied to the reference voltage inputs of memory ICs. The generated reference voltage is approximately ½ of VDDQ and tracks VDDQ changes within approximately 5 mV.

In one or more embodiments, the invention incorporates means for correcting signal-timing drift on a memory module.

Other features and advantages will become apparent from the following detailed description, taken in conjunction with the accompanying drawings, which illustrate by way of example, the features of the various embodiments.

### BRIEF DESCRIPTION OF THE DRAWING

FIG. 1 is a system block diagram illustrating the present art for providing DC power to memory modules.

FIG. 2 is a system block diagram of an alternate method of the present art for providing DC power to memory modules.

FIG. 3 is a system block diagram illustrating power distribution for point-of-load power conditioning for memory modules in accordance with the invention.

FIG. 4 is a system block diagram illustrating point-of-load power conditioning for memory modules in accordance with the invention.

FIG. 5 is a circuit diagram illustrating one embodiment for On-DIMM VDD voltage regulation circuitry for point-of-load power conditioning in accordance with the invention.

FIG. 5A is a photograph of the output display of an oscilloscope showing transient load response of regulation circuitry shown in FIG. 5.

FIG. 6 is a circuit diagram illustrating one embodiment for On-DIMM VDDQ voltage regulation circuitry for point-of-load power conditioning in accordance with the invention.

FIG. 7 is a circuit diagram illustrating voltage regulation circuitry for regulation of the reference voltage applied to the individual memory ICs on the memory module in accordance with the invention.

FIG. 8 is a circuit diagram illustrating module timing drift feedback control circuitry in accordance with the invention.

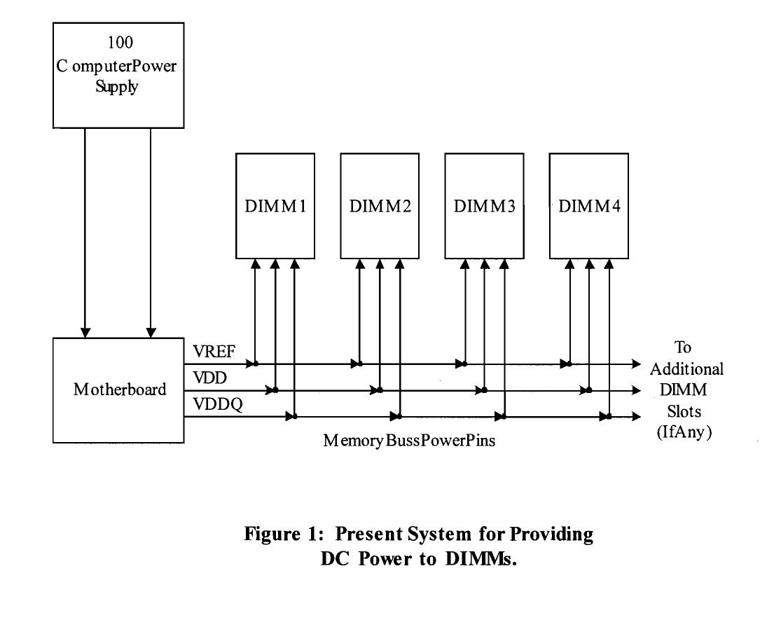

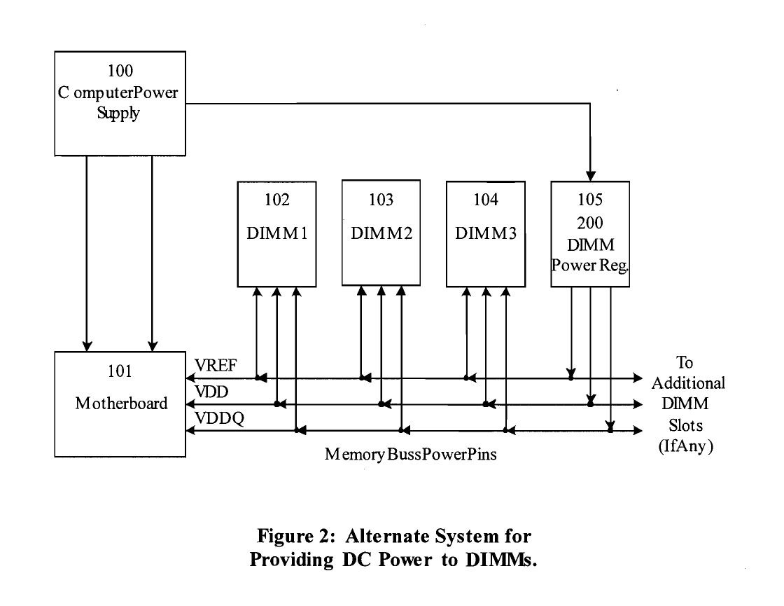

### DETAILED DESCRIPTION

The invention is directed to point-of-load power conditioning for memory modules. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention. Except as noted herein, common components and connections, identified by common reference designators function in like manner in each circuit.

The invention enables electronic circuit designers to simultaneously realize the multiple characteristics necessary to achieve high frequency operation in computer DIMM operations. In addition to regulating VDD and VDDQ to within a few mV of the reference VDDQ supplied by the computer motherboard, VREF in one embodiment is held to a value equal to 50% of VDDQ. Bias voltage variation under minimum/maximum pulse loading is less than 25 mV peak-to-peak with settling time less than 100 ns. Noise on the each bias voltage is substantially lower than in the present art. Motherboard induced noise on memory buss data and control lines is also substantially lower than with the present art.

Discussion of the invention is directed toward application to DIMMs, previously characterized as directed toward 184-pin, 2.5 Volt (VDD)/2.5 Volt (VDDQ), Unbuffered, Non-ECC, Double Data Rate, Synchronous DRAM Dual In-Line Memory Modules (DDR SDRAM DIMMs). The DIMMs utilize DDR1 type memory ICs and are intended for use as main memory when installed in PCs and network servers. While the present discussion is directed toward 184-pin DIMM modules, the invention is not so limited and can be applicable to a wide variety of modular and non-modular memory configurations as well as many non-memory device interfaces. The modular memory configurations include those incorporating DDR2 and DDR3 type memory devices as well as non-DDR, high speed video and non-video memory applications.

Point-of-Load Power Conditioning System for Memory Modules

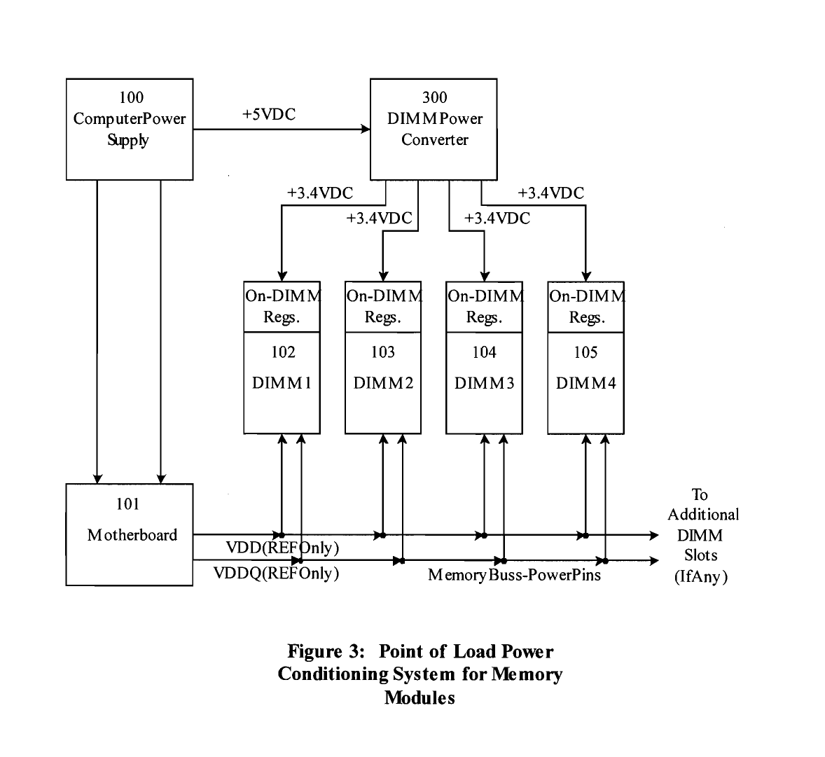

FIG. 3 illustrates an embodiment of a prime power distribution and regulation system for high-speed memory modules in accordance with the invention. Prime input power supplied to the on-module regulator(s) should be as low as practical to achieve high efficiency computer operation and minimum, memory module, power dissipation. The DIMM Power Converter (300) output voltage is approximately equal to the operating bias voltage (VDD) for the memory ICs (nominally +2.5VDC) plus the minimum drain-source voltage across the regulator power MOSFET consistent with fast response (typically 0.4 volts) plus voltage drop in the DIMM Power Converter (300) output distribution system. DIMM Power Converter (300) output voltage (+3.4 volts nominal) is approximately +3.0 volts.

Practical realization of high memory module performance typically is achieved by over-biasing VDD applied to memory ICs. The specified VDD of +2.5VDC is typically raised up to +2.85VDC using maximum motherboard capability and bios setting control. An even higher VDD voltage up to +3.0VDC is desirable but few of present motherboards have this range of capability. The maximum desired DIMM Power Converter (300) output voltage in one embodiment is approximately 3.6VDC.

There are a number of approaches for accommodating DIMM Power Converter (300) output voltage variability. In the first approach, memory modules may be operated at a fixed VDD (and VDDQ) bias voltage. One approach requires regulator reference voltages derived from either VDD (REF Only) or VDDQ (REF Only) to be replaced by a fixed value reference located either within DIMM Power Converter (300) or on memory modules (102 through 105) and communicated to DIMM Power Converter (300). The performance rationale for this approach is that having incurred the added cost associated with fast memory modules, there is no practical reason for operating them at lower bias voltages and thereby slowing down their performance. Hardware implementation is less complex and system cost lower using the first approach.

One system difficulty with the approach involves insuring that VREF on the motherboard matches VREF generated and used on DIMMs. Failure to match the references voltages may degrade or prevent high-speed performance. Motherboard VREF is set by the BIOS but may be adjusted by the user, may be specified at a different value, or the motherboard may be incapable of matching the DIMM generated VREF signal. This almost mandates a pre-configured, compatible motherboard.

A second approach involves implementation of a DIMM Power Converter (300) with adjustable output voltage that is set based on input voltage(s) from the motherboard. In the second approach, the reference voltage (VDD (REF Only) and/or VDDQ (REF Only) plus an offset voltage corresponding to the voltage drop across regulator) is communicated to DIMM Power Converter (300) which then adjusts its output voltage(s) to limit DIMM regulator power dissipation. Communication of the reference voltage to DIMM Power Converter (300) preferably uses a feedback reference signal between the converter and the DIMMs it is powering. This approach places no added requirements on the motherboard design compared to those using DIMMs of the present art. Remote voltage sense and feedback may also be employed as determined to be desirable for a particular application.

Since the number and type of DIMM modules installed in particular computers may vary widely producing a wide range of power requirements, a modular structure is used in one embodiment for DIMM Power Converter (300). Modularization can be based on either a per-DIMM breakout, or on a per-Regulator per-DIMM breakout in addition to sizing module power requirements by memory device type and quantity.

An alternative to inclusion of DIMM Power Converter (300) is for Computer Power Supply (100) to supply power directly to DIMMs (102 through 105). Computer Power Supply 100 would require independent regulation capability for DIMM power as well as capability for using input reference voltage programming and remote sensing. Since readily available, commercial, computer power supplies do not presently provide the capabilities, inclusion of independent DIMM Power Converter (300) represents a practical, near term solution to the problems of providing power to high-speed memory modules. It possesses the added benefit of being easily retrofitted into existing computer systems.

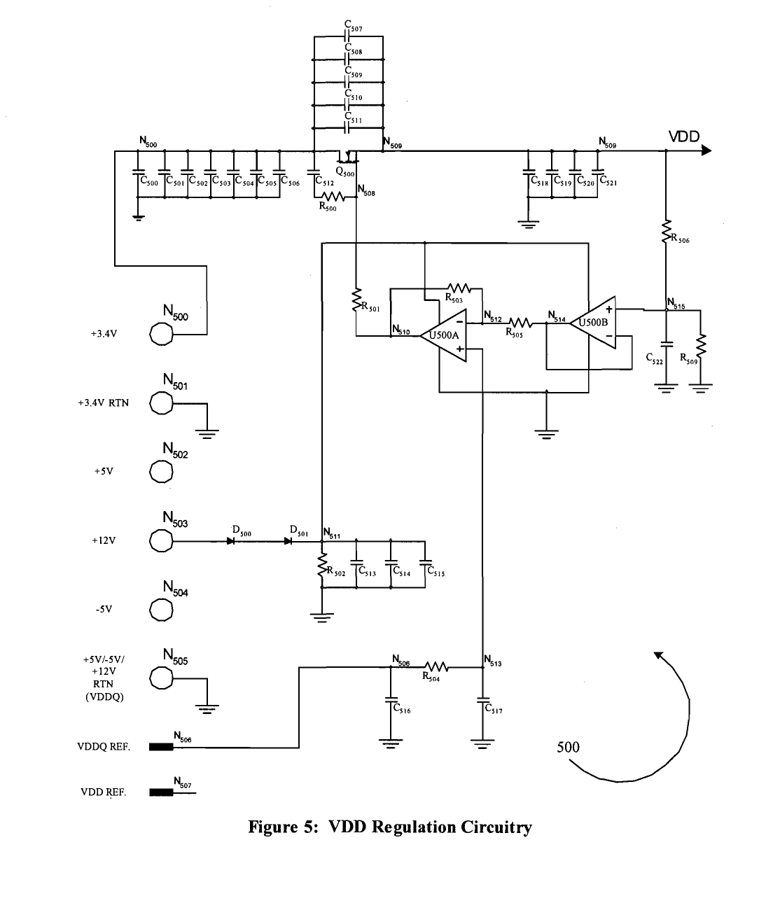

The regulators (On-DIMM Regs.) physically located on DIMM1 (102), DIMM 2 (103), DIMM3 (104) and DIMM 4 (105) may be useful elements for point-of-load power conditioning systems in accordance with the invention. The regulators should provide stable operation, fast no-load to full-load to no-load transitions with little overshoot or undershoot and fast settling time. Suitable regulation circuits are described below in sections titled: “Memory IC Bias Voltage (VDD) Regulation” and “Memory IC Data Input/Output Bias Voltage (VDDQ) Regulation”. FIG. 5A shows the transient response characteristics of the regulation circuit illustrated in FIG. 5.

Secondary Power Forms

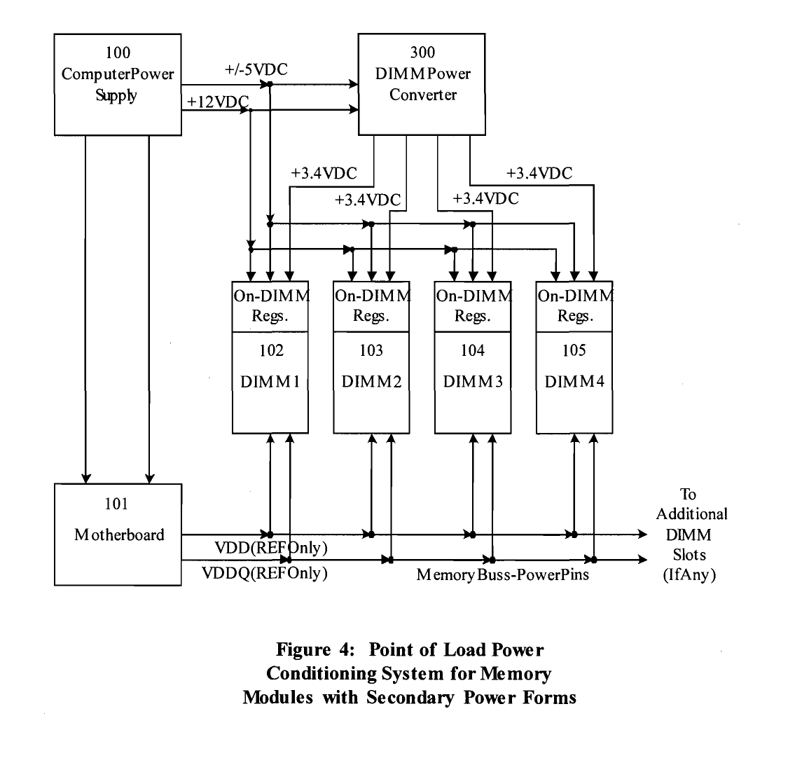

FIG. 4 illustrates an embodiment of utilization and distribution for secondary power forms in accordance with the invention. Although linear regulators can be configured that do not require the use of secondary power forms to regulate VDD and VDDQ, the use of +12V is useful for achieving fast response, fast settling, and low power dissipation. Available options are the +3.4VDC prime memory module power, +5VDC, or +12VDC (the latter 2 generally available for peripheral hardware operation). In practice, +3.4VDC and +5VDC may be too low for effectively driving a high current, power MOSFET transistor at high speeds with high transconductance. Since external power may be brought onto the memory module in the form of +3.4VDC, there is little penalty and great benefit for also bringing +12VDC onto the module as +12VDC provides superior drive signal capability for the power MOSFET.

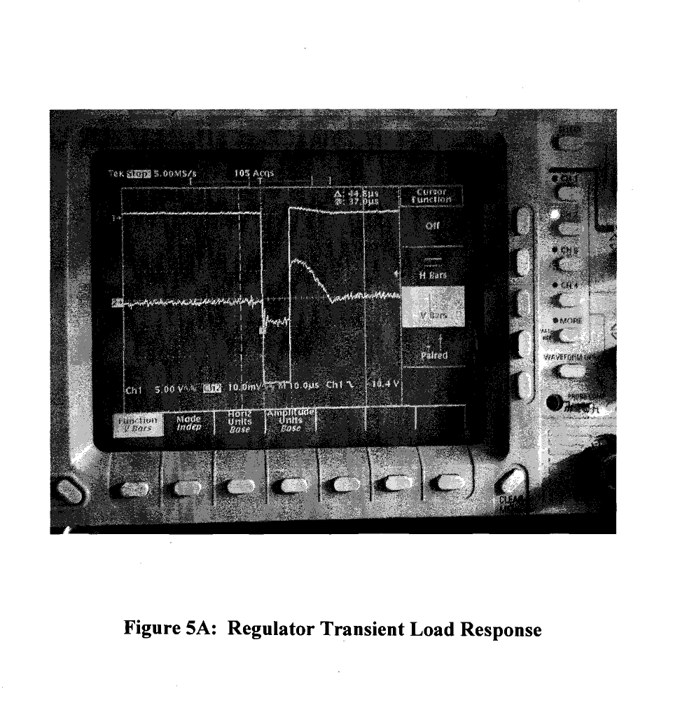

FIGS. 5 and 6 also show +5VDC and −5VDC as inputs to the memory modules even though these power forms need not be used in the invention. Future increases in memory module operating speeds may require improvement and modification of the clock, command signal, and data I/O signal interfaces. The use of new, active, high-speed interface circuits may be more easily implemented with +5VDC and −5VDC power available. Incorporation at this time within the memory module power distribution system will facilitate later standardization of DIMM power systems in accordance with the invention.

The selection of +5VDC and −5VDC as potential secondary power forms results from current ready availability. Different values may be desirable or even necessary to minimize power dissipation on very large memory, very high-speed future DIMM type designs. Like the +3.4VDC memory module prime power input, specialized voltage values would be provided by DIMM Power Converter (300) until compatible Computer Power Supplies (100) are available. The different values could be provided to the DIMMs either instead of or in addition to the +5VDC and −5VDC inputs shown in FIGS. 5 and 6. Note: most Computer Power Supplies have limited −5VDC current capacity so that even if used, an addition separate −5VDC power form would likely be required.

Memory IC Bias Voltage (VDD) Regulation

FIG. 5 illustrates an embodiment for On-DIMM regulators for the VDD voltage form for a point-of-load regulation circuit in accordance with the invention. In the following discussion, specific component values refer to a specific implementation whose performance is shown in FIG. 5A.

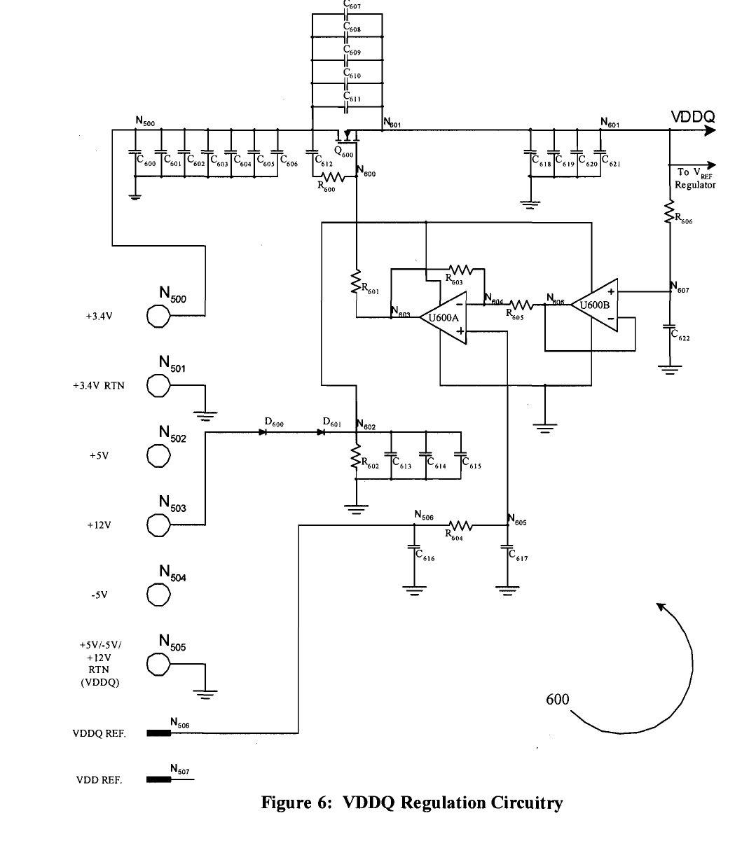

Many memory modules are made using reference designs in which VDD and VDDQ voltage forms are internally connected to common voltage and ground return planes on the memory module. Under the configurations, a single regulator supplies both power forms with the regulation circuitry shown in FIG. 6 being an appropriate configuration as it provides the input to the VREF generation circuitry shown in FIG. 7. Regulation circuitry illustrated in FIG. 5 and FIG. 6 is capable of supplying both voltage forms for at least 2 banks of ECC memory ICs.

Referring to FIG. 5, prime DIMM input power from DIMM Power Converter (300) is applied at node N500 with associated prime DIMM input power return applied at node N501. The drain, gate and source of regulation power MOSFET Q500 are coupled to node N500, node N508 and node N509 respectively. High current connections between the prime power input point and drain of MOSFET Q500 must be very low inductance structures.

Capacitors C500 through C506 couple node N500 to ground. The capacitors are of multiple types and function both to contribute to regulator stability and to store energy to supply pulse loads generated during memory IC operation. The use of 7 capacitors in the example embodiment discussed is not intended to prevent more or fewer in a particular application as long as the functionality discussed is realized in practice. Capacitors C501, C502, and C503 are typically low cost, aluminum electrolytic devices of approximately 100 uf located close to power MOSFET Q500. Capacitors C501, C502, and C503 contribute heavily to regulator stability but much less to regulator transient response due to their relatively poor high frequency characteristics.

A circuit configuration used in the design of power conversion systems is the snubber circuit, which typically consists of a resistor in series with a capacitor. Snubber circuits are typically used to damp out transients or potentially unstable operation. The large ratio between minimum and maximum load current coupled with fast output current transitions and the distances over which the memory integrated circuits are spread makes the use of snubber circuits a useful element in realization of fast, stable performance with the invention. Low overshoots and undershoots produced by fast, maximum load transitions (as shown in FIG. 5A), allow an alternate method for implementation of snubber circuit functionality.

An embodiment of a snubber circuit implementation involves replacement of the traditional series resistor-capacitor circuit with a Tantalum capacitor. Use of Tantalum capacitors offers several advantages. First, as a true capacitor, it contributes to the total, low frequency capacitance and thereby to regulator stability. Second, the lossy, high frequency characteristics of Tantalum capacitors can make their performance as snubber circuits a close match to that of the traditional configuration. Finally, Tantalum capacitors are effective, lossy filters for very high frequency noise picked up on input power lines, regulator output circuits, and ground planes. The noise includes digital circuit and switching power supply generated noise that would not be removed by traditional snubber circuits.

A drawback to use of Tantalum capacitor snubbing may be a higher cost of surface mount, chip-type, tantalum capacitors compared to common surface mount, chip-type, aluminum, electrolytic capacitors. In general, a portion of any added cost may be recovered through the use of a lower value Tantalum device. Capacitor C500 represents a 47 uf tantalum capacitor. Capacitor C518 is also a tantalum device that couples regulator output node N509 to ground and provides similar functionality to that of capacitor C500. Capacitor C518 is typically a lower value device (10 uf) than capacitor C500.

Capacitors C504, C505, and C506 are typically ceramic capacitors and contribute significantly to the transient response of the regulator. Capacitor C506 will typically be a small (100 nf) bypass type capacitor located as close to the drain of power MOSFET Q500 as practical. Capacitors C504 and C505 represent larger valued devices that store energy that may be rapidly delivered to the load to realize fast transient response. In the example circuit with response shown in FIG. 5A, capacitors C504 and C505 were implemented with 3 physical parts totaling 10 uf.

Energy stored in input capacitors described above may be transferred to the regulator output to meet fast transient load increases. Fast energy transfer is made both through power MOSFET Q500 and ceramic capacitors C507, C508, C509, C510, and C511 that couple node N500 to node N509. Capacitor C507 is typically a large ceramic device (1 uf-2.2 uf) while capacitors C508 through C511 are smaller (100 nf) devices typically used as standard bypass capacitors. Both node N500 and node N509 are low inductance structures typically implemented as large metalized planes. The number and spacing of the bypass type capacitors required depends on the physical size and location of the node structures with respect to the memory ICs.

In addition to tantalum capacitor C518 referred to above, capacitors C519, C520, and C521 couple regulator output node N509 to ground. Capacitors C519, C520, and C521 are ceramic devices of moderate size (2.2 uf each) that contribute to providing transient energy delivery to memory IC load. Capacitors C518 through C521 represent only a small portion of the capacitance on the regulator output. Bypass capacitors and distributed energy storage devices located near all DIMM memory ICs and their power input pins are a much more significant contributor.

The primary regulation control device is power MOSFET Q500. The drain, gate and source of Q500 are coupled to nodes N500, N508, and N509 respectively. On-DIMM regulator 500 employees a negative feedback control system that adjusts the gate drive to power MOSFET Q500 to correct variations in the regulator output voltage at node N509. The voltage variations are sense by resistor R506 that couples node N509 to the positive input of unity gain buffer amplifier U500B at node N515. Capacitor C522 couples node N515 to ground. Resistor R506 and capacitor C522 form a low pass filter for the node N509 voltage error signal Resistor R506 is typically low valued (100 ohms) with capacitor C522 (1000 pf) and preferable provides at least 3 dB attenuation at the first sub-harmonic of the DIMM clock.

Resistor R509 is an optional device that if incorporated allows the output voltage to be regulated at a value above the reference voltage (VDDQ REF). Resistors R506 and R509 form a voltage divider that sets the nominal output voltage. Resistor R509 may be a fixed value or variable (with or without external value command and control).

Unity gain amplifier U500B isolates the error signal sense circuitry from the input of regulation error amplifier at node N514. Resistor R505 couples the output of unity gain amplifier U500B at node N514 to the negative input of error amplifier U500A at node N512. Resistor R503 couples node N512 to the output of error amplifier U500A at node N510. Together resistors R503 and R505 set the gain for the feedback control system driving the gate of regulator power MOSFET Q500. Resistor R501 couples the output of error amplifier U500A at node N510 to the gate of MOSFET Q500 at node N508.

The error amplifier reference voltage is a filtered form of VDDQ REF input at node N506 that is coupled to the positive input of U500A at node N513. Capacitor C516, capacitor C517, and resistor R504 perform the filtering. Bias power for U500A and U500B (typically a dual operational amplifier IC with 1 bias power input) is derived from the +12VDC input at node N503. +12VDC is used in order to provide adequate voltage drive to the gate of power MOSFET Q500. However, a slightly lower voltage may be preferred as this results in faster regulator response time. Diode D500, diode D501 and resistor R502 provide the bias voltage reduction. Diodes D500 and D501 are low current (100 ma) junction devices. Capacitors C513, C514, and C515 provide filtering for the reduced voltage and bypass for amplifiers U500A and U500B.

Neutralization is the nullifying of voltage feedback from the output to the input of an amplifier through inter-node impedance of the amplifier. Resistor R500 in series with capacitor C512 couples the drain and gate of power MOSFET Q500 at nodes N500 and N508 respectively. Resistor R500 and capacitor C512 provide neutralization for regulator 500 where the inter-node impedance primarily comprises the parasitic resistance, capacitance, and inductance associated with the input capacitors coupling node N500 to ground and parasitic elements coupling the error amplifier structures to ground.

An embodiment of the invention incorporates a second feedback regulation mechanism that is substantially faster than the primary, negative feedback control loop described above. Power MOSFET Q500 is selected (IRF3711) with substantially larger current capacity than the maximum potential load current would require, and a high transconductance.

Application of an increased transient load to the regulator output causes a drop in the voltage at node N509. The drop instantaneously increases the gate-source voltage on Q500, which turns power MOSFET Q500 on harder, resulting in a virtual instantaneous increase in the drain-source current through Q500. The same mechanism described above operates in reverse for heavy-to-light load transitions and provides the fastest possible regulator response.

The current increase (or decrease) may be limited by parasitic drain and source inductances of power MOSFET Q500 plus any external circuitry in series with the inductances. The limitations make a hybrid or fully integrated FET/control IC one desirable forms of implementation. Nevertheless, a discrete embodiment will typically provide more than adequate response characteristics and will contribute greatly the realization of fast transient load response.

FIG. 5A shows performance of regulation circuitry in accordance with the invention. VDD was set to 3.0VDC. Although the minimum regulator load would be composed of the current drawn by the memory ICs (1 bank in precharge-power down-standby mode) plus current through resistors R506 and R509. For regulator test purposes, two 100-ohm resistors coupling VDD (node N509) to ground were added, providing a minimum load of 60 mA. A switched, grounded source, power MOSFET with drain coupled to VDD (node N509) through an 0.5-ohm resistor, produced the maximum pulsed loading of 5 A (larger than the maximum load of approximately 4 A for 1 bank of DDR400, ECC memory operating in a 4-bank interleaved burst mode.

Trace 1 of FIG. 5A shows the drain of the load power MOSFET with a 10 us pulsed load. Trace 2 of FIG. 5A shows the output of the regulator (VDD at node N509). Regulator undershoot is approximately 8 mV with overshoot at approximately 14 mV. The minimum load determines recovery time following the peak of the overshoot. For example, overshoot can be limited to approximately 3 mV and recovery time to approximately 0.5 us if the minimum load is increased to approximately 1 A. There is little practical benefit in general for such arbitrary waste of power. Both traces 1 and 1 are AC coupled.

Memory IC Data Input/Output Bias Voltage (VDDQ) Regulation

FIG. 6 illustrates a point-of-load regulation circuit (600) for the VDDQ voltage form in accordance with the invention. The regulation circuit is substantially the same as that shown in FIG. 5 (described above). Elements identified with designators between 500 and 599 are common physical structures (the same not equivalent) with the regulation circuit shown in FIG. 5. For example, node N500 is the prime power input for both regulation circuits. Table 1 provides a listing of corresponding (not common or shared elements) between FIGS. 5 and 6.

One difference between regulators 500 and 600 is for memory modules incorporating separate regulators for VDD and VDDQ. On the dual regulator memory modules, VDDQ regulator (600) provides the input voltage for VREF regulator (700) as illustrated. In memory modules incorporating a single regulator circuit for both VDD and VDDQ regulation, the single regulator would supply the VREF regulator (700) input voltage. In addition, if the regulated VDD voltage is above the maximum VDDQ (REF. Only) that can be supplied by the motherboard, the VDDQ regulator (600) output can be raised by incorporating a resistor of appropriate value (corresponding to resistor R509) that couples node N607 to ground.

TABLE 1
FIGS. 5 and 6 Designator Correspondence

| | |
|---|---|
| Node N508 | Node N600 |
| Node N509 | Node N601 |
| Node N511 | Node N602 |
| Node N510 | Node N603 |
| Node N512 | Node N604 |
| Node N513 | Node N605 |
| Node N514 | Node N606 |
| Node N515 | Node N607 |
| D500 | D600 |
| D501 | D601 |
| Q500 | Q600 |
| U500A | U600A |
| U500B | U600B |
| R500 | R600 |
| R501 | R601 |
| R502 | R602 |
| R503 | R603 |
| R504 | R604 |
| R505 | R605 |
| R506 | R606 |
| C500 | C600 |
| C501 | C601 |
| C502 | C602 |
| C503 | C603 |
| C504 | C604 |
| C505 | C605 |
| C506 | C606 |
| C507 | C607 |
| C508 | C608 |
| C509 | C609 |
| C510 | C610 |
| C511 | C611 |
| C512 | C612 |
| C513 | C613 |
| C514 | C614 |
| C515 | C615 |
| C516 | C616 |
| C517 | C617 |
| C518 | C618 |
| C519 | C619 |
| C520 | C620 |
| C521 | C621 |
| C522 | C622 |

Memory IC Reference Voltage (VREF) Generation and Regulation

FIG. 7 illustrates means (700) for generation and regulation of the reference voltage (VREF) applied to individual memory ICs in accordance with the invention. The nominal value of VREF is specified to be 50% of the value of VDDQ. Input to regulation circuit 700 is the VDDQ output voltage (node N601) from point-of-load regulator as illustrated in FIG. 6. A high precision resistor divider formed by resistors R700 and R701 divides the input voltage in half. Capacitor C700 is a small high frequency bypass capacitor intended to filter very high frequency noise. Capacitor C700 typically will be much less than 100 pF and together with resistor R700 should not significantly inhibit node N700 from closely tracking node N601.

Node N700 is coupled to the positive input of operational amplifier U700A. Operational Amplifier U700A is configured as a unity gain follower with output at node N701. The voltage at node N701 is coupled to the VREF input of each memory IC. Operational amplifier U700A should be selected such that it is capable of providing the total VREF current for all memory ICs on the memory module.

Timing Drift Feedback Control

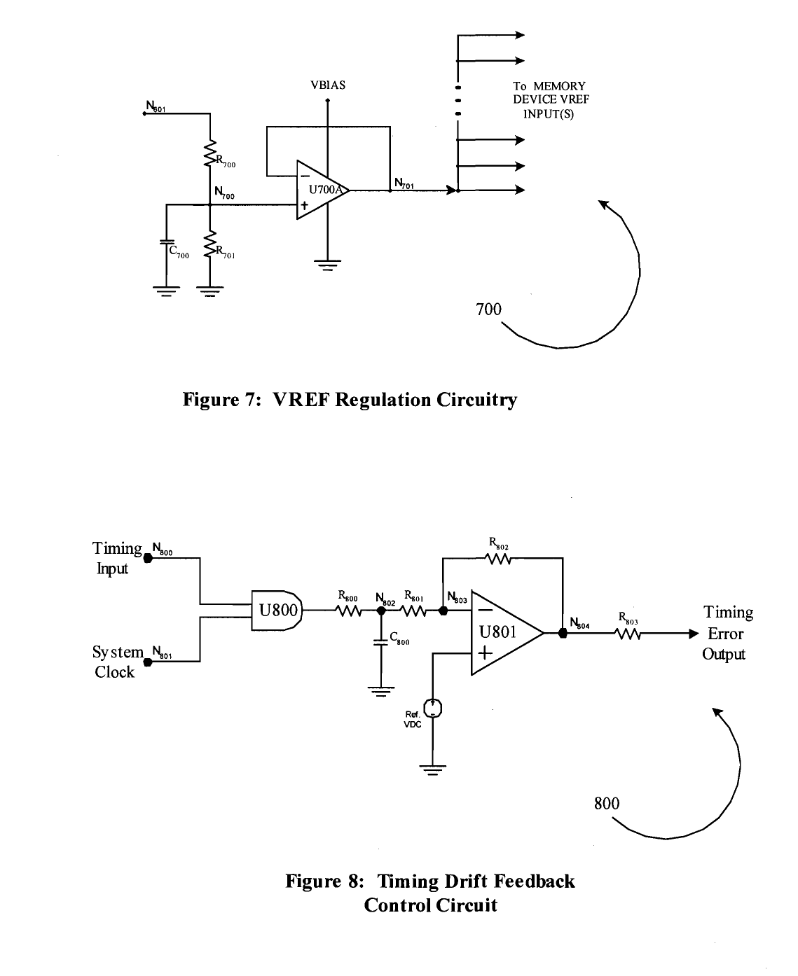

FIG. 8 illustrates example 800 of a timing drift feedback control circuit in accordance with the invention. Example 800 provides a generic circuit for sensing timing drift and generating an error signal that can be used to control means for correcting the timing drift. One such means for correcting thermally induced timing drift involves inducing a small reduction (typically a few 10's of mV) in the VDD bias voltage applied to the memory ICs. The reduction in VDD produces 2 separate correcting phenomena. First, lower VDD induces a timing shift in the opposite direction of that produced by an increase in memory device operating temperature. Second, lower VDD reduces power dissipation within the memory devices, lowering device operating temperature and again inducing a timing shift in the opposite direction of that produced by an increase in memory device operating temperature.

The generic circuit shown in FIG. 8 operates in the following manner. The two signals whose timing relationship is to be monitored are applied to the inputs of AND gate U800 at nodes N800 and N801. One input shown at node N801 is the system clock that may be used directly or indirectly in the form of a clock-synchronized signal such as 2 data strobes. Inputs to AND gate U800 at nodes may require preprocessing (not shown) in order to produce inputs which include both signal transitions whose timing relationship is to be compared and where both signals are high for a period after the second transition signal. The nature of the preprocessing depends on the specific signals being compared for timing drift. Windowing of the input signals before nodes N800 and N801 is frequently required.

The output of AND gate U800 represents a signal whose duty cycle is dependent on the timing relationship between U800 input signals. The output signal from U800 is filtered by an RC filter comprised of resistor R800 and capacitor C800. The filtered output at node N802 is applied to an error amplifier comprised of U801 and resistors R801 and R802. Output of the error amplifier at node N804 is coupled through resistor R803 to control the means for correction of the timing drift. Referring to FIG. 5, resistor R803 can be connected to the positive input of U500A at node N513 to adjust VDD and thereby achieve the previously described drift correction. The value of resistor R803 should be chosen in conjunction of the value of resistor R504 to produce the desired small voltage drop in VDD. The ref. VDC coupled to the positive input of U801 must be chosen dependent on the voltage range at node N802 and the gain of the error amplifier. Where feasible, it is simplest to use VREF as the ref. VDC signal.

Thus, point-of-load power conditioning for memory modules has been described.

What is claimed:

1. A circuit comprising:
a power supply providing a first voltage a motherboard coupled to the power supply and providing second and third voltages;
a power converter coupled to the power supply and providing a fourth voltage;
a memory module having an integrated power regulator coupled to the power converter and receiving the fourth voltage;
the memory module receiving the second and third voltages from the motherboard.

2. The circuit of claim 1 wherein the second voltage is VDD.

3. The circuit of claim 2 wherein the third voltage is VDDQ.

4. The circuit of claim 1 wherein the power converter reduces the first voltage to a lower voltage.

5. The circuit of claim 1 wherein the memory module is a DIMM memory.

6. The circuit of claim 1 further including a fifth voltage supplied by the power supply.

7. The circuit of claim 6 wherein the fifth voltage is greater than the first voltage.

8. The circuit of claim 1 wherein the fourth voltage is optimized for use by the integrated power regulator.
